(19) United States
(12) Patent Application Publication
(10) Pub. No.: US 2003/0000895 A1
(43) Pub. Date: Jan. 2, 2003

(54) Method and apparatus for cleaning waste water

(76) Inventors: Jerry Lester Hensley, Odessa, TX (US); Larry Eldon Smart, Midland, TX (US)

Correspondence Address: CONLEY ROSE & TAYON, P.C., P. O. BOX 3267, HOUSTON, TX, 77253-3267, US

(21) Appl. No.: 09/872,175

(22) Filed: Jun. 1, 2001

(51) Int. Cl. C02F 1/28

(52) U.S. Cl. 210/670; 210/195.1

(57) ABSTRACT

An apparatus and method for removing contaminants from contaminated water. One embodiment of the apparatus comprises a separation tank in which a first portion of the contaminants float to the top of the water, the tank including a water inlet and a water outlet, a coalescing device, an air injection system in which water from the tank is pressurized, passed through an air eductor so as to receive air bubbles, and returned to the tank as a gas-containing stream, a circulating mop that contacts the floating contaminants and removes them from the water, the circulating mop comprising a continuous loop of contaminant-absorbing material, a mop-cleaning member that removes contaminants from the circulating mop, and a filter system through which water leaving the separation tank via the water outlet is passed.

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

The present invention relates generally to removing pollutants from wastewater and more particularly to the separation and removal of total suspended solids (TSS) such as fats, oil and grease (FOG), and non-grease solids (e.g. food scraps), which produce an undesirable biochemical oxygen demand (BOD). Still more particularly, the present invention relates to an apparatus and method for pre-treating wastewater from restaurants, food processing facilities and other industrial operations to reduce the concentration of total suspended solids (TSS) and biochemical oxygen demand (BOD) contaminants, which place a burden on sewage piping and sewage treatment facilities.

### BACKGROUND OF THE INVENTION

Typical food preparation and clean up operations generate wastewater with high contents of foodstuff, grease and animal fat. A particular problem occurs when small molecules of grease unite with food particles and other waste and accumulate on the inside of pipelines, clogging drainage lines from sinks, dishwashers and the like. As this wastewater is discharged into the sewage system, liquid FOG cools and solidifies with other solids, accumulating on the inside walls of the wastewater pipe. As this deposited layer grows, it obstructs the flow of wastewater to the treatment facility.

The removal of these obstructions is a costly and time-consuming process. In addition, elevated levels of FOG can disrupt the treatment of waste-water at municipal facilities. Consequently, applicable governmental regulations now require removal of fats, oil and grease (FOG) from wastewater in many instances. In particular, the Environmental Protection Agency (EPA) has promulgated regulations establishing standards for acceptable total suspended solids (TSS), including fats, oil and grease (FOG), and biochemical oxygen demand (BOD) content in wastewater prior to discharge.

Because of these regulations, sewage treatment authorities have sought ways to cope with the burdens placed on their facilities by the total suspended solids (TSS), including fats, oil and grease (FOG), being discharged into the sewers. They have focused on commercial kitchen operations, such as restaurants, cafeterias, hotels, etc., to attempt to reduce the amount of such materials received or at least equitably spread the cost of treating their wastewater. One of the methods authorities have used is to apply a surcharge (fine) to sewage bills of commercial kitchen operations to reflect the added demands put upon the sewage treatment facility by sewage emanating from them. These surcharges have been levied by authorities in several ways; some inspect and levy based upon just fats, oil and grease (FOG), others by total suspended solids (TSS) and biochemical oxygen demand (BOD). In some situations, treatment authorities have required that commercial kitchens simply stop discharging into the sewers. These remedies have imposed a financial burden upon commercial kitchens but do not provide a solution in most cases and do not reduce the actual burden of pipeline clean up or treatment facilities operations.

In order to avoid surcharges and reduce the burden of pipeline clean up, it has become desirable for commercial kitchens and similar operations to remove substantially all of the total suspended solids (TSS) from their wastewater before it is discharged into a public sewage system. For example, many conventional FOG removal or recovery systems make use of the differences in specific gravity of FOG and water to permit gravitational separation of the FOG and water. Such systems typically rely on settling or other passive separator techniques.

It is also known to use grease traps, particularly inground grease traps, to separate floatable grease components from wastewater. A typical FOG-water separator, grease recovery unit (GRU) or grease trap includes a settling tank or compartment in which the wastewater is collected for gravitational separation and removal of FOG from the water. While the wastewater is within the settling container, the wastewater gradually separates into FOG and water, with the less dense FOG floating to the upper surface of the water. This upper portion, being heavily laden with FOG, is then intermittently removed from the settling container by manual removal, in the case of grease traps, or a skimming operation.

It is also known to pass the effluent through settling tanks and strainers in order to remove large or heavy food particles.

The major difficulty with all the above devices is that they operate on the premise that all FOG has a lower specific gravity than the wastewater in which it is carried. They also do not provide the residence time that is typically necessary to allow the FOG to rise to the surface. For example, while some of the very small droplets of FOG (e.g. less than 10 microns) have a specific gravity lower than the water, their slow rise rate may not allow them to reach the surface during the time the waste is in the separation compartment. Additionally, some of the FOG may adhere to foodstuff, thereby becoming heavier than the water and sinking, or worse yet, attain the same specific gravity as the water and pass through into the sewage system.

Although solids can be successfully treated in conventional sewage treatment facilities, those that contain large amounts of fats, oils and grease (FOG) require a very long residence time in the facility, which increases the expense of the treatment process. Accordingly, there is a need in the art for a new apparatus/method that achieves separation of all the TSS, thereby eliminating the FOG and at the same time reducing BOD.

### SUMMARY OF THE INVENTION

The present invention is an apparatus and method for pre-treating wastewater from restaurants, food processing facilities and other industrial operations to reduce the concentration of total suspended solids (TSS) and biochemical oxygen demand (BOD) contaminants which place a burden on sewage piping and sewage treatment facilities. A preferred embodiment of the present apparatus for removing contaminants from contaminated water comprises a separation tank in which a first portion of the contaminants float to the top of the water, the tank having a water inlet and a water outlet, a coalescing device in the separation tank, the coalescing device including means for causing a portion of the contaminants to coalesce, a circulating mop that contacts the floating contaminants and removes them from the water, a mop-cleaning member that removes contaminants from the circulating mop, and a filter system through which water leaving the separation tank via the water outlet is passed. In still more particular embodiments, the coalescing device comprises a plurality of corrugated plates that define a tortuous fluid flow path therethrough, the circulating mop comprises a continuous loop of contaminant-absorbing material, the mop-cleaning member comprises a pair of rollers, and/or the tank inlet is configured to feed water into the tank in a direction that is substantially parallel to the wall of the tank. The preferred apparatus further includes a pressurization loop that receives water from the tank, pressurizes it, and returns it into the tank in a manner that causes fluid in the separation tank to flow around the perimeter of the tank and thus produces a toroidal fluid flow pattern in the tank, an air injection system that receives water from the tank, provides it with air bubbles, and returns it into the tank, and/or a receiving device for recovering contaminants removed from the mop.

### BRIEF DESCRIPTION OF THE FIGURES

A better understanding of the present invention can be obtained when the following detailed description of the preferred embodiment is considered in conjunction with the following drawings:

FIG. 1 is a schematic diagram of a system constructed in accordance with one embodiment of the invention;

FIGS. 2A-C are enlargements of portions of FIG. 1; and

FIG. 3 is a schematic diagram of a adsorbent belt constructed in accordance with an embodiment of the invention.

### DETAILED DESCRIPTION OF THE PREFERRED EMBODIMENTS

The present invention relates to an apparatus/method for removing nearly all FOG particles from wastewater and for reducing BOD therein. To better understand the removal mechanism, the invention may be divided into four main steps: (1) straining, (2) frothing (3) separating, and (4) filtering. These steps are discussed in detail below and are performed in the present apparatus, which is preferably configured as follows.

Apparatus

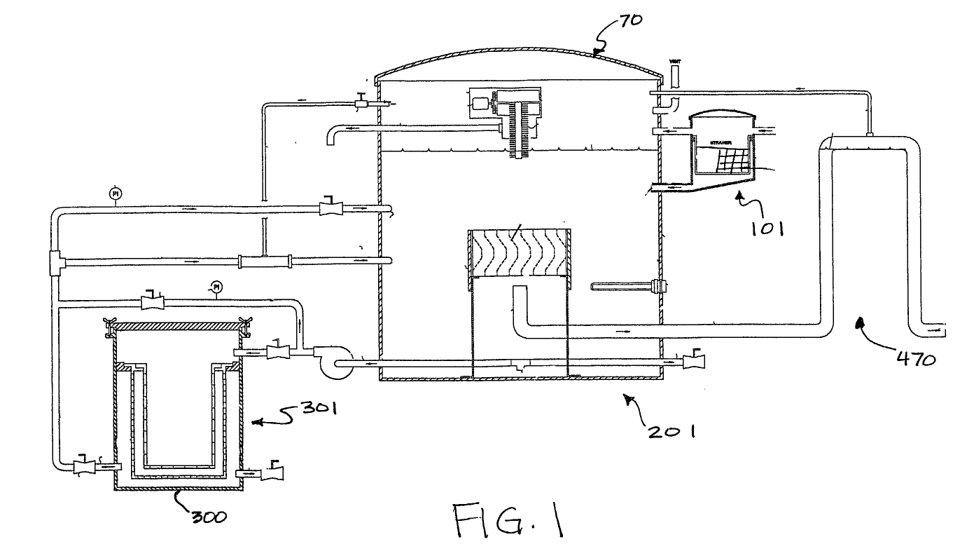

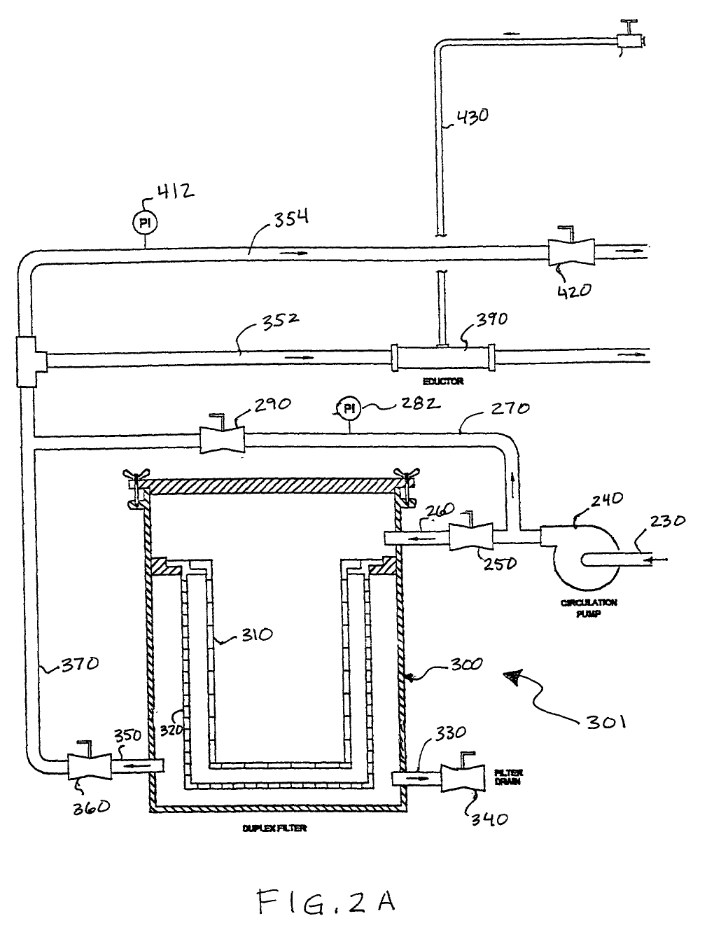

Referring initially to FIG. 1, the present invention comprises a strainer system 101, frothing system 201, and filter system 301.

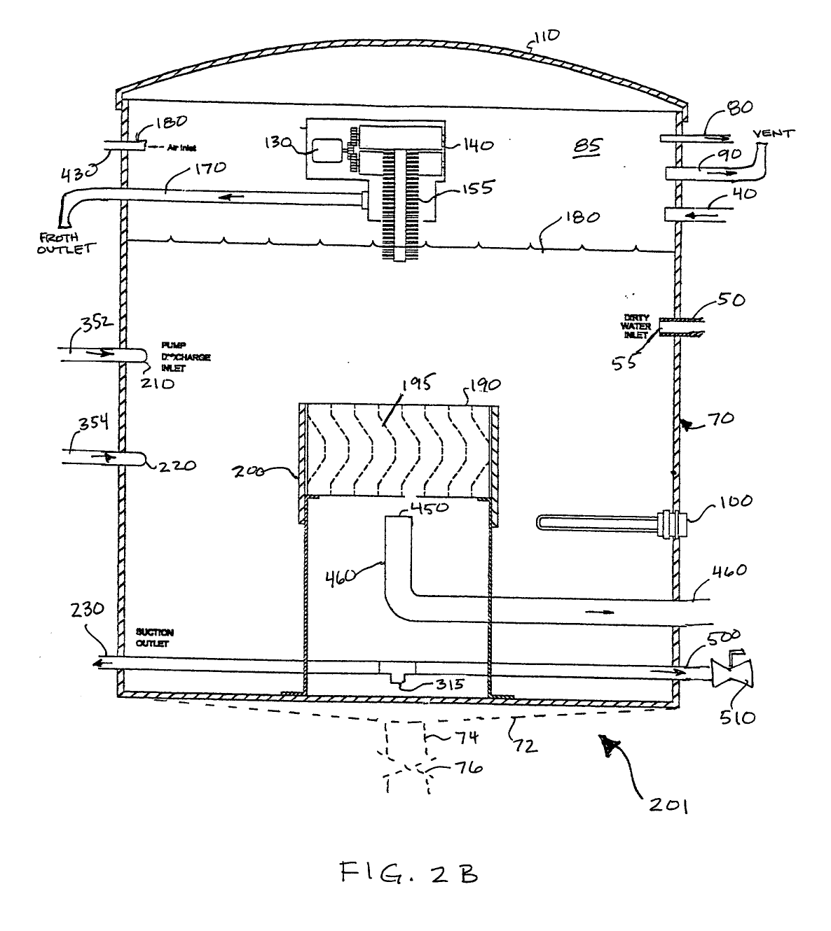

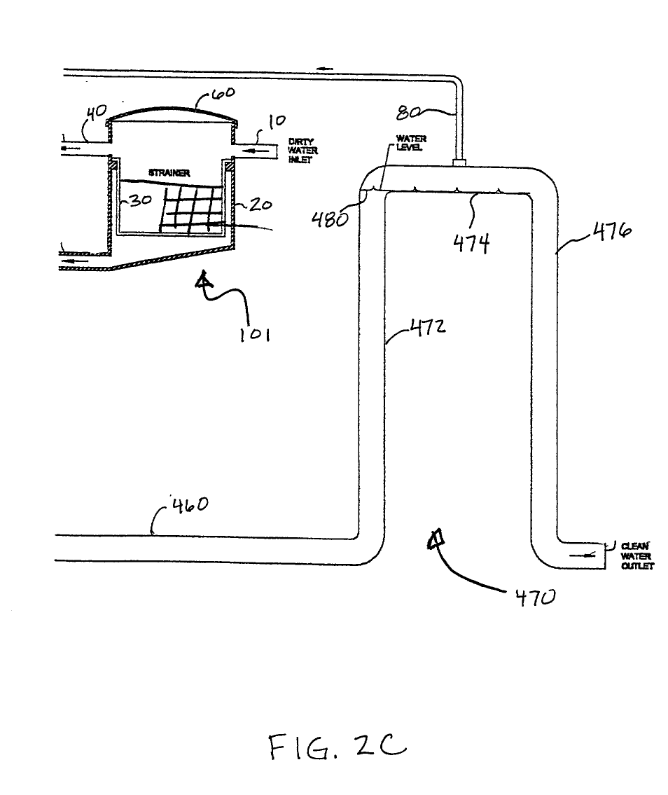

Referring now also to FIG. 2C, strainer system 101 includes an inlet 10 and a non-pressurized vessel 20 containing a perforated basket 30 and having a cover 60. Basket 30 is preferably large enough to contain all the solids larger than its openings (holes) 25 that will be discharged within a day. In some embodiments, openings 25 may be in the range of 1/16 inch to ¼ inch in diameter depending on surface area and loading. Preferably openings 25 may be 1/16 or ⅛ of an inch in diameter. Basket 30 can be automatically cleaned or removed and dumped daily. Additionally, vessel 20 has an overflow outlet 40 that allows dirty water to bypass strainer basket 30 if it becomes clogged, full, or not in service.

Referring now also to FIG. 2B, frothing system 201 includes a round or oblong tank 70 containing a corrugated plate separator 190 and an outlet pipe 460. A dirty water line 50 carries strained water from strainer system 101 to inlet 55 of tank 70. The volume of tank 70 is preferably at least three times the inlet flow rate per minute. For example, if the flow rate into the tank is 25 gallons per minute (gpm), the tank should hold at least 75 gallons. In some embodiments, tank 70 may include a lid 110 and hold-downs (not shown) that make it air tight, but it is preferred that, if present, these components are easily removed for maintenance and service.

In some instances, it may be desirable to provide one or more immersion heaters 100 within the volume of tank 70. Heaters 100 may be similar to those commonly found in large water heaters. Preferably, a heater 100 will be located directly below tank inlet 55 and below the height of the pump return fluid. The heater may operate at 110 or 220 volts, and is preferably designed for continuous duty. Heaters 100 may always remain on and should be appropriate size and number to maintain a constant temperature in the tank, preferably between 120° F. and 130° F. at all times. In some embodiments, the temperature in tank 70 is controlled using feedback from a temperature sensor in the tank.

Inlet 55 is preferably tangentially oriented, so that in-flowing water flows along the side of tank 70 and the liquid moves around separator tank 70 in toroidal flow. It is known that, for this type of flow pattern, the liquid velocity is smaller near the center of tank 70. Liquid that has been in tank 70 the longest will be in this central region. For this reason, outlet pipe 460 is preferably provided with an intake 450 that is positioned so that it receives water from the center vortex.

Still more preferably, the intake 450 is disposed such that liquid from tank 70 must pass through corrugated plate separator 190 before flowing out through intake 450. Separator 190 removes the very small droplets of free oil and mechanically emulsified oil by capturing oil droplets when they make contact with its surface. As more and more droplets attach, they coalesce until they form large enough drops to rise at a rate sufficient to overcome the downward velocity of the liquid. Separator 190 preferably includes a plurality of plates 195, which are configured so as to cause flow through the separator to be tortuous. The flow path through the separator is preferably tortuous so that droplets have an increased chance of contacting a separator surface and being captured. While a corrugated plate separator is used in this example, an incline plate separator or a coalescing pack, or other suitable device may also be used. In some embodiments, it may be preferable to include a cylindrical separator ring 200 that surrounds separator 190 and keeps water from by-passing separator 190.

In one preferred embodiment, separator plates 195 are spaced one and one-half inches (1½″) apart and compartmentalize every three and one-half inches (3½″). Preferably, each plate 195 has five flat surfaces, three of which are at 90-degree angles, and two of which are at 45-degree angles. Typically, three chevrons are pressed into the 45-degree surfaces. When a number of the plates are arranged in a pack, the liquid travels though plates in a tortuous flow pattern. For example, the water may enter separator 190 and travel vertically for one inch. It then turns and travels at a 45-degree angle for three inches. The liquid may then travel vertically for one inch before turning back and traveling at 45 degrees in the opposite direction for three inches. Finally, the liquid resumes vertical travel before exiting.

After entering outlet 460 via intake 450, the clean liquid flows into water leg 470, which has an inverted U-shape and includes ascending leg 472, lateral leg 474, and descending leg 476. Water leg 470 ensures that the liquid in tank 70 is maintained at a constant level, as indicated at 480. As discussed below, maintaining a constant liquid level in tank 70 helps ensure adequate residence time in tank 70, so as to allow natural gravitational separation to develop and coalescing time for air flotation. In come cases, the liquid may exceed constant water level 480. Water leg 470 preferably includes a siphon breaker line 80 to prevent siphoning. Preferably, tank 70 also includes a vent 90 located at or near the top of tank 70.

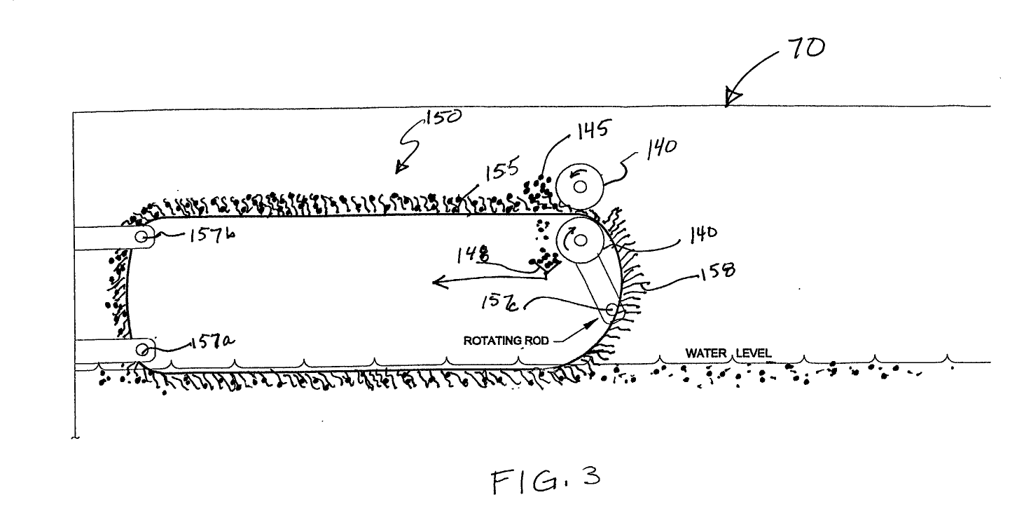

Referring now to FIG. 3, the upper portion of tank 70 includes a mopping system 150, which preferably includes a, an oleophilic continuous loop belt 155, preferably fabricated from a durable material such as nylon, with long fibers 158 sewn into it. Fibers 155 are preferably affixed to both sides of belt 155. The fibers 158 are preferably fabricated from a hydrophobic material such as polypropylene, polyethylene or any other polymerized resin to which FOG can adhere.

Referring now to FIGS. 1, 2B and 3, mopping system 150 is preferably configured such that a first portion of the path of belt 155 lies above the surface of the liquid in tank 70 and a second portion of the path of belt 155 lies at or near the surface. Between the first and second portions, belt 155 passes between a pair of opposed rollers 140. Rollers 140 are preferably mounted such that the clearance between them is only slightly larger than the thickness of belt 155.

Material that is squeezed out of fibers 158 as shown at 145 drops into a trough 148, from which it flows via pipe 170 (FIG. 2B). It will be understood an variety of devices could be used to remove material from belt 155. Suitable alternatives to rollers 140 include but are not limited to one or more combs, blades, scrapers, vacuum equipment and combinations thereof.

To support belt 155 in the preferred configuration, mopping system 150 further includes at least two, preferably three or more drive/support rods 157 positioned in a spaced-apart arrangement as shown in FIG. 3. Specifically, at least one rod, lower rod 157a, maintains a portion of the belt path near the surface of the liquid. A second rod, upper rod 157b, maintains a portion of the belt path above the surface of the liquid. A third rod, end rod 157c is preferably laterally spaced apart from lower rod 157a. If the diameter of at least one of the rods is large enough to lift a sufficient portion of belt 155 out of the liquid, lower rod 157a or upper rod 157b may be eliminated.

In one embodiment, one or both rollers 140 drive belt 155 and are driven in turn by a motor 130. In another embodiment (not shown), one of rods 157 is driven by a motor and thus drives belt 155, while the remainder of rods 157 rotate passively. Belt 155 and the drive rod(s) 157 can be provided with corresponding sets of teeth or the like, which allow the drive rod to more effectively engage belt 157, if desired.

Referring again to FIG. 2B, heavy solids tend to settle to the bottom of tank 70. A suction inlet 315 is positioned at the bottom of tank 70 and connected to a suction pump 240 via filtration line 230, allowing water and heavy solids to be drawn off simultaneously. In an alternative embodiment, the bottom of tank 70 can be slightly conical, as shown in phantom at 72 ins FIG. 2B. In this embodiment, an additional outlet 74 can be provided to allow settled solids to be removed from tank 70. The shape and utility of outlet 74 will depend in part on the nature of the solid wastes entering tank 70. A valve 76 may be provided to control the flow through outlet 74.

Referring now also to FIG. 2A, after passing through pump 240, liquid from filtration line 230 is preferably fed into filter system 301 via pressurized feed line 280. Filter system 301 preferably comprises a vessel 300, first and second filters 310, 320, a clean water outlet line 350, and a drain line 330. A valve 340 controls the flow through drain line 330 and a valve 360 controls the flow through outlet line 350.

Filtration unit 325 is a duplex system, using two filters 310, 320, having different mesh sizes. In some embodiments, a triplex filter may be used for very fine filtration. Depending upon the discharge specifications, filters may have various mesh sizes. Preferably, filter 310 is relatively coarse (from about 75 microns to about 40 microns), while, filter 320 is fine (between about 20 microns and about 10 microns). One or both of these filters may be constructed of woven wire mesh, sintered metal, woven fiber mesh, felt socks or the like. In a preferred embodiment, both filters are made of woven wire mesh.

When selecting a filter material, filter vessel 300 should be designed to insure that the filter elements can be easily removed and easily cleaned. It is important that the filters are designed with enough surface area to allow for an acceptable run time between cleaning and possess a low clean differential pressure drop.

Filtered water that has passed through first and second filters 310, 320 can leave vessel 300 via either line 330 or line 350. Liquid leaving vessel 300 via line 350 enters either a gas-entraining line 352 or a liquid injection line 354. Gas-entraining line 352 preferably includes an eductor 390. As is known in the art, as liquid passes through eductor 390, air is entrained into the liquid stream. Air enters eductor 390 via a gas entrainment line 430, which includes an air intake 180 located either in the head space 85 of tank 70, as shown, or outside tank 70. The rate of air flow through line 430 is controlled by a valve 440. When the air-flow through is restricted by valve 440 to a point very close to causing cavitation within eductor 390, very small bubbles (<5 microns) are generated in the fluid flowing in line 352.

The contents of line 352 are injected into tank 70 via a tangential inlet 220, which is preferably located at about one-half the depth of the liquid in tank 70. Because line 352 contains entrained air, this results in a flow of air bubbles into and up through the contents of tank 70. In tank 70, these small bubbles contribute to successful operation of the present air flotation process.

Once the bubbles pass through the liquid in separation tank 70, they break back out into the head space 85 of tank 70.

Similarly, liquid injection line 354 feeds a liquid stream into tank 70 via a tangential inlet 210. Since this liquid stream contains no entrained air, it is not as preferred that the stream be injected at about half the liquid depth. A valve 420 controls the flow of fluid in line 354.

It is preferred that the fluid pressure in lines 352, 354 be substantially greater than the fluid pressure in tank. In addition, as mentioned above, both inlet 210 and inlet 220 are configured such that liquid entering tank 70 has a velocity vector that is horiztonal and parallel to the tank wall at the point of entry. The momentum of this entering fluid is imparted to the fluid in the tank, with the result that circular flow is generated in tank 70. Because of friction with the walls and floor, this in turn results in a toroidal flow pattern, in which liquid flows down along the walls, inward across the floor, upward in the center of the tank and outward at the liquid surface. The toroidal flow tends to sweep particles that have fallen to the tank floor toward the center of tank 70, where suction inlet 315 is located.

A bypass line 270 preferably connects pressurized feed line 280 to gas-entraining line 352 and liquid injection line 354. Valve 250 preferably controls the flow of liquid through line 280. When valve 250 is closed, liquid is shunted around filter system 301 via bypass line 270. A control valve 290, or check valve (not shown), or both, is preferably included on bypass line 270.

It should be noted that not all water exiting tank 70 via pump discharge outlet 315 enters pump 240. Rather, in some cases, such as when it is determined that the water at the tank bottom is sufficiently clean, the water may be allowed to flow through separation drain outlet 500 and drain valve 510. Typically, the drain valves are not used during operation and are used onlyu to drain the vessels for maintenance.

Operation

Initially, FOG-containing liquid is poured into a sink or other drain. The liquid flows into a strainer, where the large particles (herein defined as >2 mm) are removed. This strainer can be of the basket type, which requires manual removal and dumping, or an automatic type that continuously dumps the collected solids.

Frothing

After the large solids are removed, the liquid and remaining solids are introduced into tank 70 as a toroidal stream. In one embodiment, pump draws liquid from the center of the tank and injects it tangentially to the tank wall, thereby enhancing toroidal flow. This in turn has the effect of lengthening the fluid flow path and increasing residence time. Chamber residence time can be estimated by measuring the distance the liquid must travel between the inlet and the outlet, determining the linear velocity at the inlet or outlet, then dividing the distance by the velocity. A long flow path allows more participation of the liquid within the tank; flow patterns in tank 70 are preferably maintained such that the last liquid entering the tank is the last liquid out. Hence, a long flow path increases the residence time that the liquid stays within tank 70. By increasing the residence time, more time is allowed for gravitational separation to occur. This means that those particles that have a difference in specific gravity will either rise or sink within the liquid.

It is preferable for small bubbles to be educted into the liquid while it is circulating in tank 70. This is achieved by using a portion of pressurized liquid from pump 240 as a motive for eductor 390, which induces small air bubbles into the stream. The air is derived from vapor space in the top of the tank and is recycled from the tank to the eductor. This liquid/air mixture is then fed into tank 70, where it is circulated through the liquid in the tank (due to toroidal flow). All of the liquid will pass through the rising air bubbles many times before reaching the exit. After passing through the liquid, the air rises back to the vapor space in the top of the tank. As the tiny air bubbles rise through the liquid, they contact and adhere to some of the small solid particles.

Even though these small particles may be heavier than the liquid, they may attach to the bubbles and be carried to the top of the liquid. Oil separation is further enhanced because rising bubbles (1) cause small oil droplets to attach to them or (2) push the small oil droplets together, coalescing them into larger droplets. As these oil droplets continue to increase in size and density, their buoyancy or velocity rise rate will increase according to Stokes' Law, shown by Equation 1.

F=6πrηv (1)

where F is the force acting in resistance to the fall, r is the radius of the sphere, η is the viscosity of the liquid, and v is the velocity of fall.

As the bubbles attach to solids and the small oil droplets coalesce into larger droplets, a froth composed of oil, solid particles and air forms and collects on the surface of the liquid. Once the froth has accumulated on the surface of the liquid, it is removed by the mop system 150.

As described above, by making the liquid flow through a torturous path and at low velocity (herein defined as <6 feet per second) before leaving tank 70, almost all of the small FOG droplets come in contact with corrugated separator plate 190. Once contact is made the droplets will attach, migrate upward into chevrons, coalesce and form into large enough drops to rise to the surface.

Because the smallest droplets of oil are often not effectively removed by gravity separation, even when the separation is enhanced by gas sparging, the FOG content of the liquid leaving tank 70 via pipe 460 often exceeds environmental standards. To reduce the small droplets of oil, and the overall FOG content, a corrugated plate separator is used to collect the oil by attaching to the oil when the oil makes contact with its surface. As more and more of the droplets attach they will coalesce and form large enough drops to rise at a rate to overcome the downward velocity of the liquid.

Separating

As mop 150 passes through the froth at the surface of the liquid, bubbles and solid and liquid particles of FOG and the like cling to its fibers and are lifted out of the liquid. This material is removed from the belt fibers by opposed rollers 140. As discussed above, the material is squeezed out of the fibers 158 as shown at 145 and drops into a trough 148, from which it flows via pipe or trough 170 into a collection container (not shown). It is preferred to remove the froth soon after it forms because over time the air will break out of the froth, allowing heavy solids to sink. If desired, a blade or other mechanical device (not shown) can be used to facilitate the collection of the recovered material after it is squeezed out of the belt.

If desired, heat may be used to aid the separation process. Because heat is lost as the wastewater passes through piping and the skimmer basket into the separation tank, it is preferable to add heat to maintain a constant process temperature. This prevents solids and FOG from forming into large globules. Heat can be added by the use of one or more electric immersion heater elements placed in the liquid, such as element heating 100, a heat exchange system, or other suitable heating mechanisms. By increasing or maintaining the temperature between 115° F. and 130° F., FOG will separate freely from those solids and rise to the top. At the same time, the solids will sink to the bottom. In order to prevent temperature loss and reduce the electric heating cost, piping and tanks should be insulated. This is important when the restaurant is not discharging hot water into the system.

Filtering

As discussed above, by increasing the time the liquid has between the inlet and the outlet, most of the particles will rise to the top or sink to the bottom. The toroidal stream creates a vortex that causes heavy particles that have sunk to the bottom of the tank to move to the center of the tank, where they can be removed by suction inlet 315 or outlet drain 74.

In order to remove the solids that have collected on or near the bottom of the separation tank, they are withdrawn and passed through a specially designed filter system for removal. This is done by placing the suction of the eductor pump near the center of the separation tank and placing the filter between the pump discharge and the eductor or tank return. Like the inlet strainer, this filter system needs to be emptied and cleaned periodically. The filter preferably removes particles down to the 10 micron range, thereby insuring that the total liquid quality exiting the separation tank will be within discharge specifications.

Pump 240 pressurizes the liquid to a predetermined pressure that allows filtration, air eduction and force for producing the toroidal flow. Typical pressure is between 20 and 50 psig. The flow rate through pump 240 is preferably at least two times the flow rate through inlet 55. For example, if the system has an inlet flow rate of 10 gpm, then the pump discharge should be at least 20 gpm. The discharge rate of pump 240 is preferably greater than the flow through inlet 55 because the passage of water through filters 310, 320 does nor result in complete removal of solids. Therefore, it is preferred to remove and clean at least two tank volumes for each new wastewater volume added.

In a preferred embodiment, filtration unit 301 includes two inline pressure indicators 282, 412, which indicate fluid pressure upstream and downstream of the filters, respectively. When valve 290 is closed, indicator 282 will indicate the pressure in pressurized feed line 280. When valve 420 is closed, indicator 412 will indicate the pressure in gas-entraining line 352. By comparing the pressures at the two indicators, it is possible to determine when the pressure differential across the filters reaches a point where the filter elements need to be cleaned. Filter bypass line 270 may be used during the time the filters are being cleaned. Because this is such a short time and dilution would not be greatly affected, filtration system 301 does not need to be shut down. The filters are preferably cleaned when no wastewater is entering the system (e.g. when the restaurant is closed).

### EXAMPLE

All tests were conducted in an operating restaurant using actual wastewater. On average, the restaurant serves over 14,000 meals per month and has a total water usage of 183,000 gallons per month.

Testing was performed on approximately 25% of the total water from the kitchen. The water used was from the sink where the pots, pans and all dishes were rinsed before the dishes went into the dishwasher. This water had the highest overall levels of FOG and TSS tested.

Using the present invention, TSS was significantly reduced. Results are shown below in table 1.

TABLE 1
TSS Results

| Time | TSS content |
|---|---|
| (hours) | (mg/L) |
| 0* | 1679 |
| 1 | 368 |
| 2 | 250 |
| 24 | 108 |
| 1-4** | 367 |

*The TSS entering the system after a passin through a coarse strainer was 1679 mg/L, of which 900 mg/L was FOG.
**This is a composite sample comprised of small samples collected every 15 minutes during the first four hours of operation.

Samples were collected during the heaviest loading times (e.g. midday and early evening). The city collects samples over the entire time the restaurant is open. Typically, it collects a composite sample every 15 minutes from the time the restaurant opens until it closes. This is similar to the composite sample collected in table 1.

Because good results were obtained using the dirtiest water, it is believed that the present invention will yield even better results when all the restaurant discharge water is used.

While the present invention has been disclosed and described in terms of a preferred embodiment, the invention is not limited to the preferred embodiment. For example, while the present invention has been described for treatment of waste water streams such as are generated in restaurants and food preparation facilities, it should be understood that the present apparatus is useful for treating a variety of waste streams. In addition, various modifications to the apparatus, including the arrangement and size of the components, among others, can be made without departing from the scope of the invention. For example, valves recited herein can be any suitable flow control mechanism, including gate valves, ball valves, and the like, pumps recited herein can be any suitable pressure-increasing mechanism, including impellers, positive displacement pumps and the like, and filters recited herein can comprise any suitable particulate removal mechanism, including mesh, screen, porous materials, and the like. In the claims that follow, any recitation of steps is not intended as a requirement that the steps be performed sequentially, or that one step be completed before another step is begun, unless explicitly so stated.

What is claimed is:

1. An apparatus for removing contaminants from contaminated water, comprising:
a separation tank in which a first portion of the contaminants float to the top of the water, said tank having a water inlet and a water outlet;
a coalescing device in said separation tank, said coalescing device including means for causing a portion of the contaminants to coalesce;
a circulating mop that contacts the floating contaminants and removes them from the water;
a mop-cleaning member that removes contaminants from the circulating mop; and
a filter system through which water leaving the separation tank via said water outlet is passed.

2. The apparatus according to claim 1 wherein said coalescing device comprises a plurality of corrugated plates that define a tortuous fluid flow path therethrough.

3. The apparatus according to claim 1, further including a pressurization loop that receives water from said tank, pressurizes it, and returns it into said tank in a manner that causes fluid in said separation tank to flow around the perimeter of said tank and thus produces a toroidal fluid flow pattern in said tank.

4. The apparatus according to claim 1, further including an air injection system that receives water from said tank, provides it with air bubbles, and returns it into said tank.

5. The apparatus according to claim 4 wherein said air injection system receives water from said filter system.

6. The apparatus according to claim 1 wherein said circulating mop comprises a continuous loop of contaminant-absorbing material.

7. The apparatus according to claim 1 wherein said mop-cleaning member comprises a pair of rollers.

8. The apparatus according to claim 1 wherein said tank inlet is configured to feed water into said tank in a direction that is substantially parallel to the wall of said tank.

9. The apparatus according to claim 1 wherein said filter system includes at least two filters.

10. The apparatus according to claim 1, further including a receiving device for recovering contaminants removed from said mop.

11. An apparatus for removing contaminants from contaminated water, comprising:
a separation tank in which a first portion of the contaminants float to the top of the water, said tank having a water inlet and a water outlet;
a circulating mop that contacts the floating contaminants and removes them from the water; and
a mop-cleaning member that removes contaminants from the circulating mop.

12. The apparatus according to claim 11 wherein said tank inlet is configured to feed water into said tank in a direction that is substantially parallel to the wall of said tank.

13. The apparatus according to claim 11, further including a filter system through which water leaving the separation tank via said water outlet is passed.

14. The apparatus according to claim 13 wherein the filter system includes at least two filters.

15. The apparatus according to claim 11 wherein said circulating mop comprises a continuous loop of contaminant-absorbing material.

16. The apparatus according to claim 11 wherein said mop-cleaning member comprises a pair of rollers.

17. The apparatus according to claim 11, further including a receiving device for recovering contaminants removed from said mop.

18. The apparatus according to claim 11, further including an air injection system in which water from said tank is pressurized, passed through an air eductor so as to receive air bubbles, and returned to said tank.

15. A method for removing contaminants from contaminated water, comprising:
(a) flowing the contaminated water for an amount of time through a separation tank;
(b) allowing a first portion of the contaminants to float to the top of the water in the separation tank;
(c) removing the first portion of the contaminants from the water by contacting the first portion of the contaminants with a mop; and
(d) removing water that is substantially free of the first portion of the contaminants from the separation tank.

16. The method according to claim 15 wherein step (a) includes passing the contaminated water through a coalescing device.

17. The method according to claim 16 wherein said coalescing device comprises a plurality of corrugated plates defining a tortuous fluid flow path therethrough.

18. The method according to claim 15, further including:
(e) allowing a second portion of the contaminants to settle to the bottom of the water in the separation tank.

19. The method according to claim 15 wherein the mop is a continuous loop.

20. The method according to claim 15, further including removing the first portion of the contaminants from the mop and recovering said first portion of the contaminants.

21. The method according to claim 15, further including:
(e) passing the water removed from the separation tank in step (d) through at least one filter so as to generate filtered water.

22. The method according to claim 21, further including:
(f) pressurizing at least a portion of the filtered water, passing the pressurized filtered water through an eductor so as to produce gas-containing filtered water, and injecting the gas-containing filtered water into the tank.

23. The method according to claim 15, further including causing water in the separation tank to flow in a toroidal flow pattern.
